(19) United States
(12) Patent Application Publication
(10) Pub. No.: US 2009/0089828 A1
(43) Pub. Date: Apr. 2, 2009

(54) BROADCAST TELEVISION PARENTAL CONTROL SYSTEM AND METHOD

(75) Inventors: Eric Stephen Carlsgaard, Zionsville, IN (US); Mark Gilmore Mears, Zionsville, IN (US)

Correspondence Address: FLETCHER YODER P.C., 7915 FM 1960 RD. WEST, SUITE 330, HOUSTON, TX, 77070, US

(73) Assignee: SHENZHEN TCL NEW TECHNOLOGY LTD, Shenzhen (CN)

(21) Appl. No.: 11/865,426

(22) Filed: Oct. 1, 2007

(51) Int. Cl. H04N 7/16

(52) U.S. Cl. 725/28

(57) ABSTRACT

There is provided a system and/or method of displaying video and/or audio content. An exemplary method comprises receiving input regarding a type of potentially objectionable content that is to be filtered from display of the video content, receiving a video signal containing an indication marking an occurrence of potentially objectionable video content in the video signal and a type of the potentially objectionable video content, and filtering the video signal at the occurrence if the type of the potentially objectionable video content corresponds to the type of potentially objectionable video content that is to be filtered when displaying the video content.

### BACKGROUND

This section is intended to introduce the reader to various aspects of art which may be related to various aspects of the present invention that are described below. This discussion is believed to be helpful in providing the reader with background information to facilitate a better understanding of the various aspects of the present invention. Accordingly, it should be understood that these statements are to be read in this light, and not as admissions of prior art.

Known parental control systems for live or broadcast television may use ratings information about entire programs to permit a parent to either allow the entire program to be viewed or block the entire program based on an indication that the program contains potentially objectionable content (POC). In addition, closed caption data may be monitored during live television broadcasts so that objectionable audio data may be muted based on parental control settings. In the area of video playback, such as viewing video data stored on DVDs, some known systems provide data regarding when to skip certain video scenes or mute audio of certain portions of the program based on parental control settings. An improved parental control system is desired.

### BRIEF DESCRIPTION OF THE DRAWINGS

In the drawings:

FIG. 1 is a block diagram of an electronic device that may employ a parental control system in accordance with an exemplary embodiment of the present invention;

FIG. 2 is a process flow diagram in which the display of POC is filtered in a live television scenario in accordance with an exemplary embodiment of the present invention;

FIG. 3 is a diagram depicting video content before and after the application of blank-out filtering of POC in accordance with an exemplary embodiment of the present invention;

FIG. 4 is a diagram depicting video content before and after the application of freeze-frame filtering of POC in accordance with an exemplary embodiment of the present invention; and

FIG. 5 is a diagram depicting video content before and after the application of pixilated filtering of POC in accordance with an exemplary embodiment of the present invention.

### DETAILED DESCRIPTION OF THE PREFERRED EMBODIMENT

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication and manufacture for those of ordinary skill having the benefit of this disclosure.

Traditional parental control systems do not allow a user to watch an entire live television program while blocking only selected types of objectionable visual material from scenes. Exemplary embodiments of the present invention provide a better-tailored parental control system and method. For example, an embodiment of the present invention may allow a user (e.g., a parent) to select a level of filtering to be applied for different types of visual and audible POC that is present in live television programming. Indeed, present embodiments may block a portion of a scene (e.g., a series of video frames) in a television program based on indicator data associated with the portion of the scene. Such indicator data may be submitted along with the television program by a broadcaster. The indicator data may mark POC in the program and corresponding presentation times to facilitate blocking the POC when it occurs. Blocking may include distorting or completely preventing presentation of audio and/or video output based on the POC in accordance with present embodiments. For example, blocking may include blanking the screen, freezing the last acceptable frame, or pixilation of the screen during the time associated with the POC.

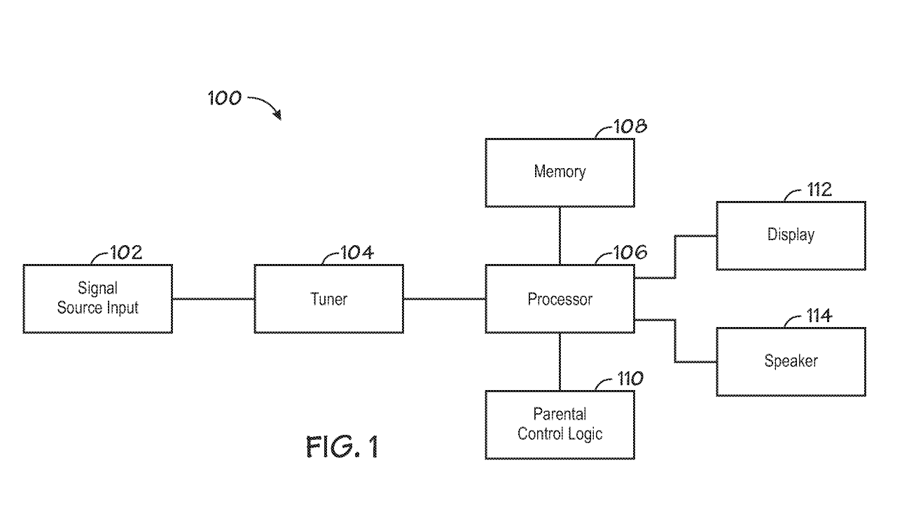

FIG. 1 is a block diagram of an electronic device that may employ a parental control system in accordance with an exemplary embodiment of the present invention. The electronic device is generally indicated by reference numeral 100. The electronic device 100, which may include a television, DVD player, set-top box or the like, comprises various subsystems represented as functional blocks in FIG. 1. Those of ordinary skill in the art will appreciate that the various functional blocks shown in FIG. 1 may comprise hardware elements (including circuitry), software elements (including computer code stored on a machine-readable medium) or a combination of both hardware and software elements.

Specifically, in the illustrated embodiment, the electronic device 100 includes a signal source input 102, a tuner 104, a processor 106, a memory 108, a parental control logic feature 110, a display 112 and a speaker 114. The signal source input 102 may comprise an antenna input, a cable input, an RCA input, an s-video input, a composite video input or the like. Those of ordinary skill in the art will appreciate that, although only one signal source is shown, the electronic device 100 may have multiple signal source inputs. For example, the electronic device 100 may include a first signal source input that receives a broadcast signal and a second signal source input that receives a stored video signal, such as an input from a DVD player. In an exemplary embodiment of the present invention, the signal source received by the signal source input 102 comprises video data and/or audio data along with POC indicator data, which will be discussed in detail below.

In the illustrated embodiment, the tuner 104 is communicatively coupled with the signal source input 102. The tuner 104 is adapted to tune a particular video program from a broadcast signal received from the signal source input 102. In some embodiments the tuner 104 may be by passed if the signal source input 102 receives a stored video signal. Indeed, those of ordinary skill in the art will appreciate that input signals that are not received as part of a broadcast spectrum may by pass the tuner 104 because tuning is not required to isolate a video program associated with those signals.

The processor 106 is adapted to control the overall operation of the electronic device 100. Such control may be achieved by the processor 106 when the processor 106 cooperates with the memory 108 to perform operations in accordance with embodiments of the present invention. Specifically, for example, the memory 108 may be associated with the processor 106 such that the memory 108 stores machine-readable computer code that causes the processor 106 to control the operation of the electronic device 100 in a manner in accordance with present embodiments.

The parental control logic feature 110 may include hardware, software or a combination thereof. For example, in one embodiment, the parental control logic feature 110 may include a software program stored in memory (e.g., the memory 108). The parental control logic feature 110 is adapted to receive information regarding one or more particular types of POC to be filtered when video content is displayed. Examples of video POC that may be filtered include sexual content, violence, drug use or the like. Additionally, the parental control logic feature 110 may receive and store information on a specific filtering level by which to filter each particular type of POC. For example, a user may specify that POC of a sexual nature is to be filtered at a high level, POC depicting violence is to be filtered at a medium level, and POC depicting drug use is to not be filtered at all. The level of filtering selected determines the amount of filtering. For example, if a high level of filtering is selected for POC of a violent type, every frame of a scene that includes any violence may be blocked. Alternatively, only scenes with higher than mild violence may be blocked when a medium level of filtering is selected, and only the worst violence may be blocked when a low level of filtering is selected.

The display 112 of the electronic device 100 is configured to display video data initially received via the signal source input 102. Specifically, the display 112 may only display content initially received via the signal source input 102 and that has been filtered in accordance with present embodiments. The display 112 may comprise a liquid crystal (LCD) display, a liquid-crystal-on-silicon (LCOS) display, a digital light projection (DLP) display or any other suitable display type. The display 112 may include a lighting source (not shown) that is used to facilitate presentation of a visible image on the display.

In an exemplary embodiment of the present invention, the video signal received by the signal source input 102 includes what may be referred to as POC indicator data. POC indicator data may comprise information identifying POC contained in the video data by its type and its occurrence in time. For example, POC indicator data may include an indication that sexual content is present in the video or scene occurring from minute 31 to minute 34 of a television program. The POC indicator data may be inserted into an audio/video (A/V) stream of a transmitter. For an Advanced Television Systems Committee (ATSC) video stream, the time associated with the POC may be indicated by a time stamp that corresponds with the applicable frame or frames. Further, the POC indicator data may be included in a program and system information protocol (PSIP) data packet with an appropriate header identifying it as video parental control data. Such information may be repeated as necessary for proper operation. The POC indicator data may be provided for a group of frames by giving a start time and a stop time of the sequence of POC. In an analog system, the POC indicator data may be inserted as extended data service (XDS) data in blanking intervals of the corresponding video frames.

In an exemplary embodiment of the present invention, the processor 106 operates to block the display of video having a type of POC that has been selected for filtering by the user only at the time at which the video is set to be displayed. For example, when the POC would normally be displayed, the processor 106 may cause the screen to go blank or cause pixilation of the video data during the POC. The remainder of the program (i.e., the portion that does not contain the POC) is displayed, in its unfiltered state, to the viewer. For example, based on the POC indicator data and a comparison with user-defined or preset restriction values, embodiments of the present invention may block a three minute scene from being presented on the display 112 because it includes sex, drugs and/or violence.

Embodiments of the present invention may facilitate various types of blocking. For example, video may be distorted (e.g., pixilated), blanked out or frozen. A single type of blocking may be utilized consistently based on a user's preference or different types of blocking may be utilized based on the type of POC present in the video. For example, a level of filtering applied to a particular type of POC may change the method by which the display is obscured when a particular type of POC is detected in the input video signal. Examples of filtering levels that may be applied include high filtering, medium filtering and low filtering. For POC having a high level of filtering, the entire screen area may be blocked by the processor 106. For example, if a user indicates that sexual content should be highly filtered, the screen may go black or present a blocking message when POC with sexual content is present in the video data. Medium filtering may result in the most previous “clean” frame being temporarily frozen by the processor 106, wherein “clean” refers to video data that does not include POC or does not include POC that is outside of the range allowed for display. For example, a frame of video that is acceptable may be frozen on the display 112 just before a violent scene and the display 112 may continue to present the frozen view until the violent scene has ended. Low filtering may only apply a video effect such as blurring or pixilation to the entire screen area during POC that is of a type or degree assigned the lowest level of filtering. It should be noted that audio data may also be blocked via different methods. For example, audio data may be muted, bleeped or scrambled based on the POC indicator data and the level of filtering.

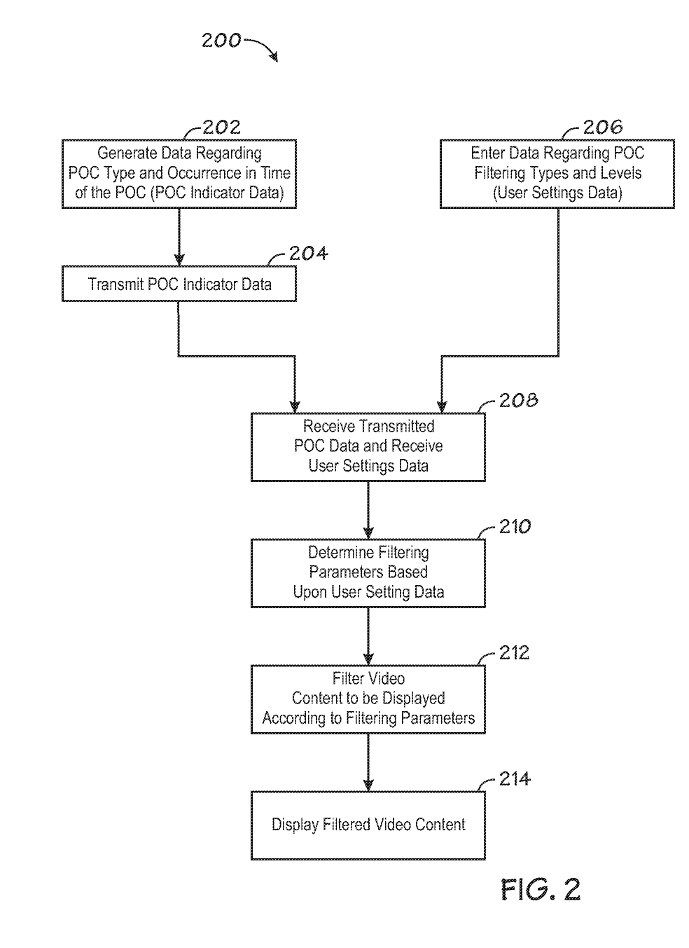

FIG. 2 is a process flow diagram in which the display of POC is filtered in a live television scenario in accordance with an exemplary embodiment of the present invention. The method is generally indicated by reference numeral 200. At block 202, the process 200 begins by generating data regarding the type of POC and the time at which the POC occurs. The data generated in block 202 may be referred to as POC indicator data. The POC indicator data may be supplied by a broadcaster along with the associated program data. For example, experienced video editors employed by the broadcaster may review programming and identify POC. Alternatively, content may be reviewed for presence of POC by a producer of content such as a movie studio, an independent company, council or the like. The identified POC may be associated with a type of POC, given a rating level and associated with a time of occurrence during the programming. This information may then be utilized to define the POC indicator data, which may be inserted into the broadcast stream along with the other programming information.

At block 204, the POC indicator data is transmitted. For example, block 204 may represent transmitting the POC indicator data in a broadcast signal along with the associated program data. At block 206, data may be entered by a user regarding POC filtering types and levels. In other words, block 206 represents receiving input regarding user-selected filter settings (user settings data). At block 208, the POC indicator data and the user settings data are received. Block 208 may represent isolating the POC indicator data from a bitstream. At block 210, filtering parameters (for example, POC type to be filtered and level of filtering to apply) are determined based upon the user settings data. For example, block 210 may include interpreting answers to user-friendly questions regarding data filtering into actual filter settings or parameters. At block 212, the video content to be displayed is filtered according to the filtering parameters and the associated POC indicator data. At block 214, the filtered video content is displayed. In some embodiments, the filtered video may be displayed by showing the video corresponding to the received video signal with selected blocking methods being applied to selected POC types. Those of ordinary skill in the art will appreciate that this process flow diagram may work for audio data in the same manner as it does for video data.

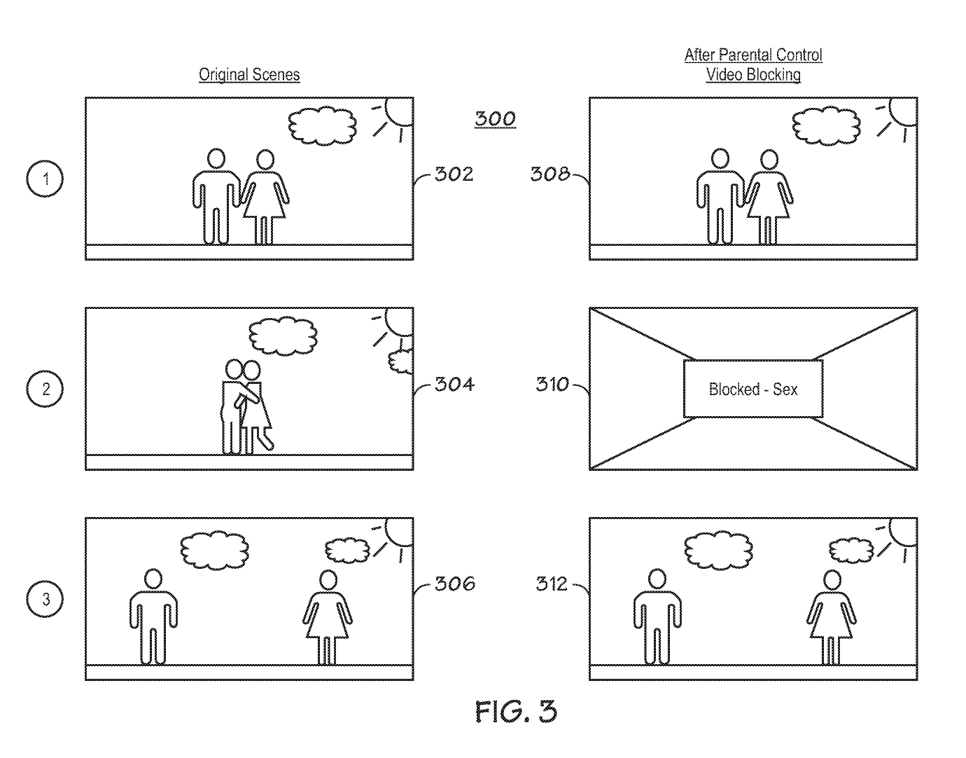

FIG. 3 is a diagram depicting video content before and after the application of blank-out filtering of POC in accordance with an exemplary embodiment of the present invention. The diagram is generally indicated by reference numeral 300. Blocks 302, 304 and 306 represent three consecutive original (before filtering) display screens of video content. In this exemplary embodiment, block 304 illustrates a display of video content that includes POC of a sexual nature. Blocks 308, 310 and 312 represent three consecutive display screens resulting from a filtering process in accordance with present embodiments being applied. Block 310 represents a display in which the entire display screen was blanked at the time the video content of a sexual nature occurred. If the filtering depicted by block 310 had not occurred, the video content displayed would have been that illustrated by block 304. As set forth above, a heavy level of filtering may be associated with blanking the entire display screen at the time of the occurrence of POC. For example, the exemplary results illustrated in blocks 308, 310 and 312 of FIG. 3 may have been achieved because a user provided settings for a device in accordance with present embodiments to heavily filter POC of a sexual nature, wherein heavy filtering was associated with blank-out filtering.

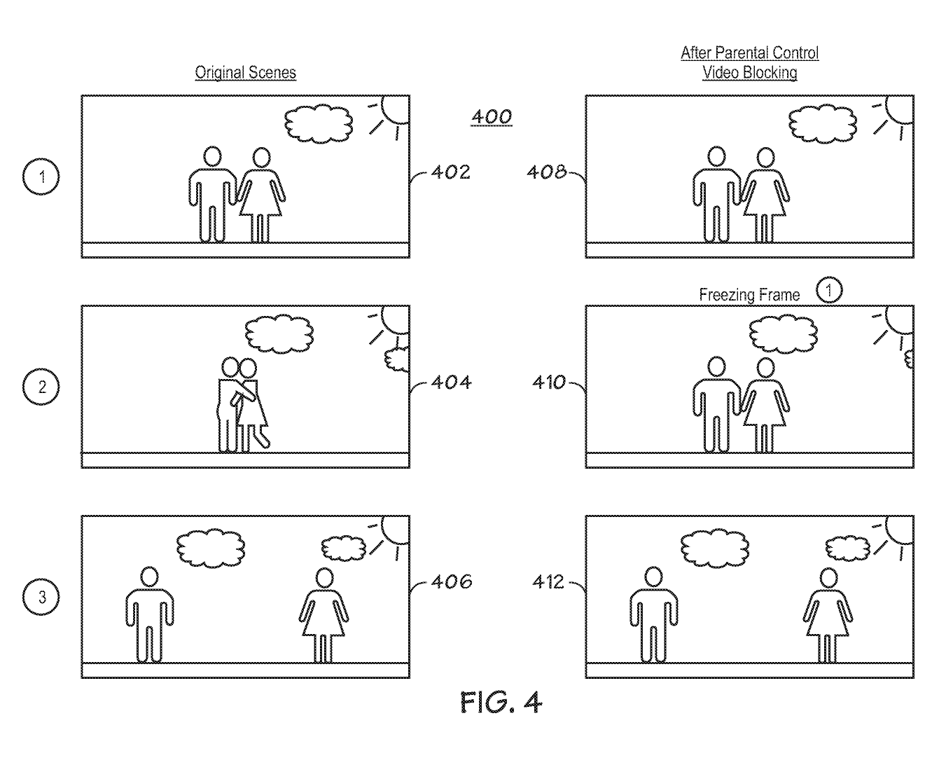

FIG. 4 is a diagram depicting video content before and after the application of freeze-frame filtering of POC in accordance with an exemplary embodiment of the present invention. The diagram is generally indicated by reference numeral 400. Blocks 402, 404 and 406 represent three consecutive original (before filtering) display screens of video content. In this exemplary embodiment, block 404 illustrates a display of video content that includes POC of a sexual nature. Blocks 408, 410 and 412 represent three consecutive display screens resulting from a filtering process in accordance with present embodiments being applied. Block 410 represents a display in which the most previous clean frame is temporarily frozen at the time the video content of a sexual nature occurs. If the filtering depicted by block 410 had not occurred, the video content displayed would have been that illustrated by block 404. As set forth above, a medium level of filtering may be associated with freezing the most recent clean frame during the occurrence of the POC. For example, the exemplary results illustrated in blocks 408, 410 and 412 of FIG. 4 may have been achieved because a user provided settings for a device in accordance with present embodiments to provide medium filtering of POC of a sexual nature, wherein medium filtering was associated with freeze frame filtering.

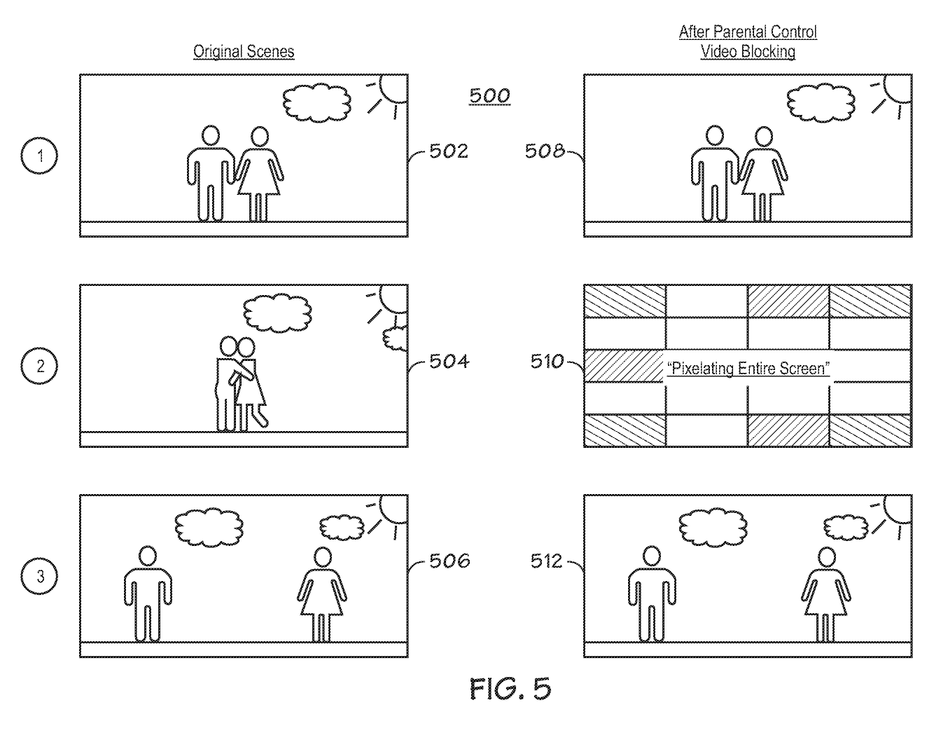

FIG. 5 is a diagram depicting video content before and after the application of pixilated filtering of POC in accordance with an exemplary embodiment of the present invention. The diagram is generally indicated by reference numeral 500. Blocks 502, 504 and 506 represent three consecutive original (before filtering) display screens of video content. In this exemplary embodiment, block 504 illustrates a display of video content that includes POC of a sexual nature. Blocks 508, 510 and 512 represent three consecutive display screens resulting from a filtering process in accordance with present embodiments being applied. Block 510 represents a display in which the entire display screen is pixilated at the time the video content of a sexual nature occurs. If the filtering depicted by block 510 had not occurred, the video content displayed would have been that illustrated by block 504.

Pixilation may include using an average gray level and color of each 8×8 block (or other size block) of pixels over the whole image. In some embodiments, a user may designate the level of pixilation to be used (e.g., 8×8 or 32×32 blocks). In some embodiments, only a portion of the screen may be pixilated. Further, in some embodiments another type of image blurring may be employed. As suggested above, a light level of filtering may be associated with blurring or pixilating all or a portion of the display screen during occurrence of the POC. For example, the exemplary results illustrated in blocks 508, 510 and 512 of FIG. 5 may have been achieved because a user provided settings for a device in accordance with present embodiments to provide light filtering of POC of a sexual nature, wherein light filtering was associated with pixilation or blurring.

While the invention may be susceptible to various modifications and alternative forms, specific embodiments have been shown by way of example in the drawings and will be described in detail herein. However, it should be understood that the invention is not intended to be limited to
the particular forms disclosed. Rather, the invention is to cover all modifications, equivalents and alternatives falling within the spirit and scope of the invention as defined by the following appended claims.

1. A method of displaying video content, comprising:
receiving input regarding a type of potentially objectionable content that is to be filtered from display of the video content;
receiving a video signal containing an indication marking an occurrence of potentially objectionable video content in the video signal and a type of the potentially objectionable video content; and
filtering the video signal at the occurrence if the type of the potentially objectionable video content corresponds to the type of potentially objectionable video content that is to be filtered when displaying the video content.

2. The method recited in claim 1, comprising receiving input regarding a type of filtering to apply.

3. The method recited in claim 2, wherein the type of filtering comprises blank-out filtering.

4. The method recited in claim 2, wherein the type of filtering comprises freeze-frame filtering.

5. The method recited in claim 2, wherein the type of filtering comprises pixilated filtering.

6. The method recited in claim 1, wherein the type of potentially objectionable content that is to be filtered comprises one or more of video content of a sexual nature, video content relating to illegal drug use or video content relating to violence.

7. The method recited in claim 1, comprising generating a potentially objectionable video content filtering level.

8. The method of claim 7, wherein the potentially objectionable video content filtering level comprises heavy filtering, medium filtering or light filtering.

9. The method recited in claim 7, comprising blank-out filtering the video signal at an occurrence time of the potentially objectionable video content if the filtering level comprises heavy filtering.

10. The method recited in claim 7, comprising freeze-frame filtering the video signal at an occurrence time of the potentially objectionable video content if the filtering level comprises medium filtering.

11. The method recited in claim 7, comprising blurring or pixilating the video signal at an occurrence time of the potentially objectionable video content if the filtering level comprises light filtering.

12. An electronic device, comprising:
a display;
a signal source input configured to receive a signal containing data indicative of a type of potentially objectionable video content that is to be displayed in a corresponding video output to the display and data containing an indication marking an occurrence of the potentially objectionable video content to be displayed;
a parental control logic feature adapted to receive input regarding a type of potentially objectionable video content that is to be filtered; and
a processor adapted to filter display of video content at the occurrence of the potentially objectionable video content if the data indicative of the type of potentially objectionable video content that is to be displayed corresponds to the type of potentially objectionable video content that is to be filtered.

13. The electronic device recited in claim 12, wherein the parental control logic feature is adapted to receive input regarding a type of filtering to apply.

14. The electronic device recited in claim 13, wherein the type of filtering comprises blank-out filtering, freeze-frame filtering or pixilated filtering.

15. The electronic device recited in claim 12, wherein the type of potentially objectionable video content that is to be filtered comprises one or more of video content of a sexual nature, video content relating to illegal drug use or video content relating to violence.

16. The electronic device recited in claim 12, wherein the parental control logic feature is adapted to generate a potentially objectionable video content filtering level.

17. The electronic device recited in claim 16, wherein the potentially objectionable video content filtering level comprises heavy filtering, medium filtering or light filtering.

18. The electronic device recited in claim 12, wherein the processor is adapted to:
perform blank-out filtering of the video signal at an occurrence time of the potentially objectionable video content if the filtering level comprises heavy filtering;
perform freeze-frame filtering of the video signal at the occurrence time of the potentially objectionable video content if the filtering level comprises medium filtering; and
perform blurring or pixilation filtering of the video signal at the occurrence time of the potentially objectionable video content if the filtering level comprises light filtering.

20. An electronic device that is adapted to display video content, the electronic device comprising:
means for receiving input regarding a type of potentially objectionable content that is to be filtered from display of the video content;
means for receiving a video signal containing an indication marking an occurrence of potentially objectionable video content in the video signal and a type of the potentially objectionable video content; and
means for filtering the video signal at the occurrence if the type of the potentially objectionable video content corresponds to the type of potentially objectionable video content that is to be filtered when displaying the video content.
